(19) United States
(12) Patent Application Publication
(10) Pub. No.: US 2024/0279971 A1
(43) Pub. Date: Aug. 22, 2024

(54) ADJUSTABLE DAMPED SNAP-ACTING HINGE

(71) Applicant: D.G.N. S.R.L., MODENA (IT)

(72) Inventor: Daniele ZETTI, REGGIO EMILIA (IT)

(73) Assignee: D.G.N. S.R.L., MODENA (IT)

(21) Appl. No.: 18/289,931

(22) PCT Filed: May 3, 2022
(86) PCT No.: PCT/EP2022/061858

§ 371 Date: Nov. 8, 2023

(30) Foreign Application Priority Data
May 13, 2021 (IT) 102021000012311

(51) Int. Cl. E05D 3/16; E05F 1/12

(52) U.S. Cl. CPC E05D 3/16; E05F 1/1261; E05D 2003/163

(57) ABSTRACT

An adjustable damped snap-acting hinge, comprising a first articulated quadrilateral which comprises a coupling element which can be associated with a fixed element, a first portion of a first lever and a third lever which are associated in an articulated manner with the coupling element, and a first portion of a second lever, which is interposed between the preceding levers and is articulated thereto, and a second articulated quadrilateral which comprises a fixing element which can be associated with an element that can move with respect to the fixed element, a second portion of the second lever and a fourth lever which are associated in an articulated manner with the fixing element, and a second portion of the first lever which is interposed between the preceding levers and is articulated thereto. The hinge is further provided with first elastic compression means.

The present invention relates to an adjustable damped snap-acting hinge.

In the furniture manufacturing sector, in particular for furniture for caravans, camper vans, boats and truck cabs, hinges are known for articulating a door leaf that closes a corresponding compartment of an item of furniture about a substantially horizontal axis, such as those normally employed in wall cupboards and the like. Such hinges must allow the movement of the door leaf between a closed configuration, in which it is directed downward so as to occlude the corresponding compartment, and an open configuration, in which it is rotated and raised upward to allow access to that compartment.

These hinges are, essentially, constituted by a first articulated quadrilateral and by a second articulated quadrilateral, which are provided with a first lever and a second lever in common and which have, respectively, a coupling element for coupling to a fixed element of an item of furniture that defines a compartment, and a fixing element for fixing to a movable element for closing the compartment. Such hinges are adapted to assume alternately a closed configuration and an open configuration, in which the fixing element assumes two different arrangements by performing an angle of rotation conventionally called an “angle of aperture”, which can vary on the basis of the requirements of the specific application.

In order to support the weight of the door leaf in the open configuration and in order to ensure the holding of the closed configuration, such hinges must be fitted with first and second elastic compression means, which are interposed between the elements respectively of the first and of the second quadrilateral, as described for example in European patent no. EP 1,736,627 B1 in the name of this same applicant.

Furthermore, it is known to have hinges of the type described above fitted with a damping element that acts when being closed to prevent the door leaf from slamming against the furniture frame, with consequent noise and risk of crushing. A solution of this kind is known from European patent application no. EP 3,312,372 A1 in the name of this same applicant.

The dimensioning of the elastic means of such hinges must be calculated as a function of the weight of the door leaf to be moved, of the number of hinges used to support it, and of the presence of any automatic snap-acting locking devices to be activated when being closed.

The correct dimensioning of the elastic means used is essential in order to obtain furniture that is practical and convenient for users, but which is also reliable and safe over time.

The angle of aperture of the hinge must also be selected on the basis of the requirements of the specific application, for example in order to prevent the risk of the door leaf in the open configuration from knocking against other, adjacent objects.

For this reason it is necessary to provide a vast range of hinges with different elastic means and opening angles.

For makers, this fact entails the need to have in storage a great variety both of components and of assembled hinges, with considerable complication of flows of materials and increases in the associated running costs.

In order to overcome, at least partially, such drawbacks an adjustable snap-acting hinge is known from European patent no. EP 2,762,666 B1 in the name of this same applicant, which has a system for adjusting the preloading of the first elastic means and a system for setting the angle of aperture. This hinge, however, does not have a damping element.

Such adjustment system is positioned outside the first articulated quadrilateral, on the opposite side with respect to the second articulated quadrilateral, and comprises a threaded element engaged in a corresponding female thread, which are interposed between a fixed locator and a mobile locator which supports an element for supporting the first elastic means and is articulated to the coupling element.

By acting on the threaded element to screw/unscrew it into/out of the female thread, it is possible to modify the inclination of the movable locator with respect to the coupling element and as a consequence the position of the element for supporting the first elastic means, by varying the corresponding preloading.

Furthermore, the setting system consists of a screw engaged in a threaded hole provided on one of the levers of the first quadrilateral, and adapted to abut against another lever of the first quadrilateral in the open configuration, to define a settable stroke limit.

By acting on such screw to screw/unscrew it into/out of the corresponding hole, it is possible to modify the angle of aperture of the hinge.

However, this known solution is also not devoid of drawbacks among which is the fact that the preloading adjustment system positioned outside the first quadrilateral considerably increases the overall bulk of the hinge, and therefore it risks limiting the possibilities for its use.

Furthermore, the elements of such adjustment system remain exposed and visible, such that they penalize the compactness and the aesthetic value of the hinge, in addition to the risk of the onset of malfunctions as a consequence of the buildup of dust or other residues in the coupling region between the threaded element and the female thread.

Furthermore, such hinge is fitted with the adjustment system only on the first elastic means and not on the second elastic means.

The hinge also does not incorporate a damping element and is dimensioned to obtain an angle of aperture that can be varied in the neighborhood of 90°.

The aim of the present invention is to eliminate the above mentioned drawbacks in the background art, by providing an adjustable damped snap-acting hinge that makes it possible to obtain maximum flexibility in the adjustment of the preloading of the elastic means inserted in one or both of the articulated quadrilaterals, while having contained encumbrances and a compact design.

Within this aim, an object of the present invention is to obtain a hinge that can be used for different types of door leaves, with or without automatic locking systems when closed, by acting on the adjustment of the preloading of the elastic means, so as to reduce the number of components to have in stock and of models of hinges to be produced, with consequent reduction of management costs.

Another object of the present invention is to prevent dust or other debris from being deposited on the elements of the system for adjusting the preloading of the elastic means, so as to optimize the reliability thereof.

Another object of the present invention is to be able to also have a system for setting the angle of aperture of the hinge, in a wide range of values.

Another object of the present invention is to be able to have a damping element.

Last but not least, another object of the present invention is to provide a simple structure which is easy and practical to implement, safe in use and effective in operation, and of low cost.

This aim and these and other objects which will become better apparent hereinafter are all achieved by the present adjustable damped snap-acting hinge, which has the characteristics recited in the appended claim 1 and is optionally provided with one or more of the characteristics in the subsequent dependent claims.

Further characteristics and advantages of the present invention will become better apparent from the detailed description of some preferred, but not exclusive, embodiments of an adjustable damped snap-acting hinge, which are illustrated for the purposes of non-limiting example in the accompanying drawings wherein:

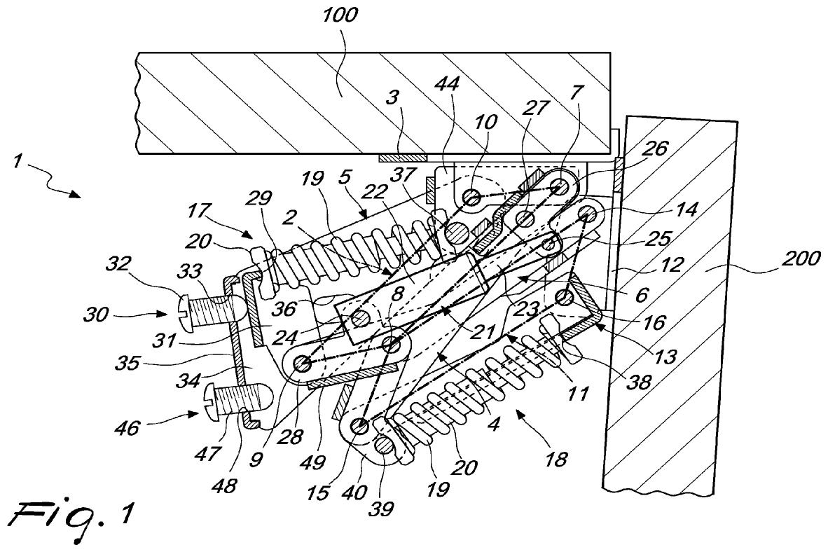

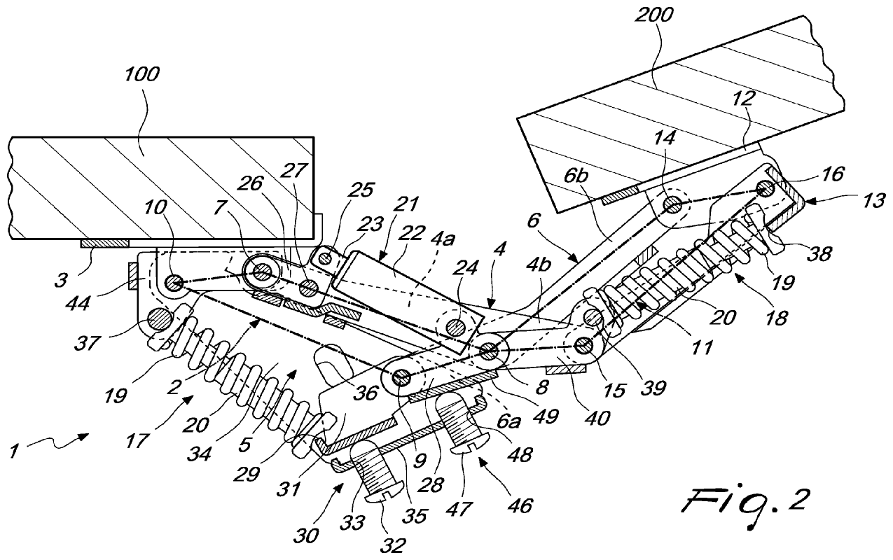

FIGS. 1 and 2 are cross-sectional views taken along a central plane of a first embodiment of an adjustable damped snap-acting hinge according to the invention, respectively in the closed configuration and in the open configuration;

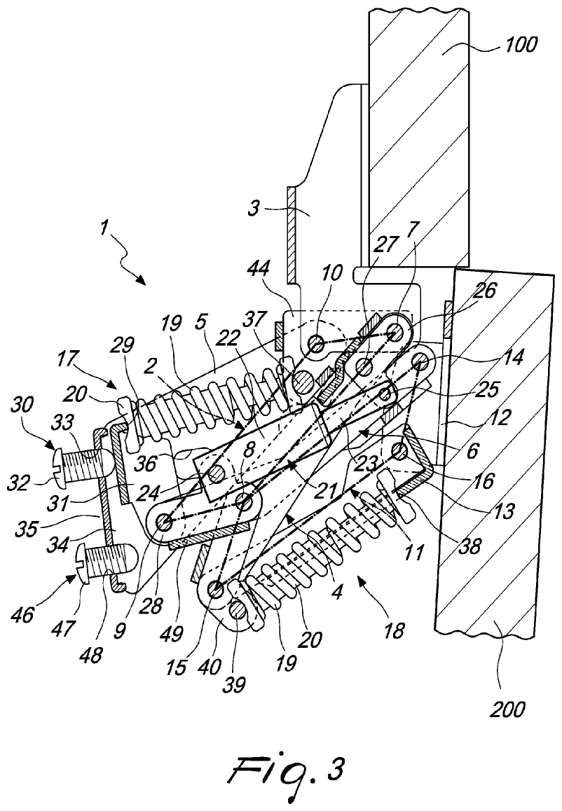

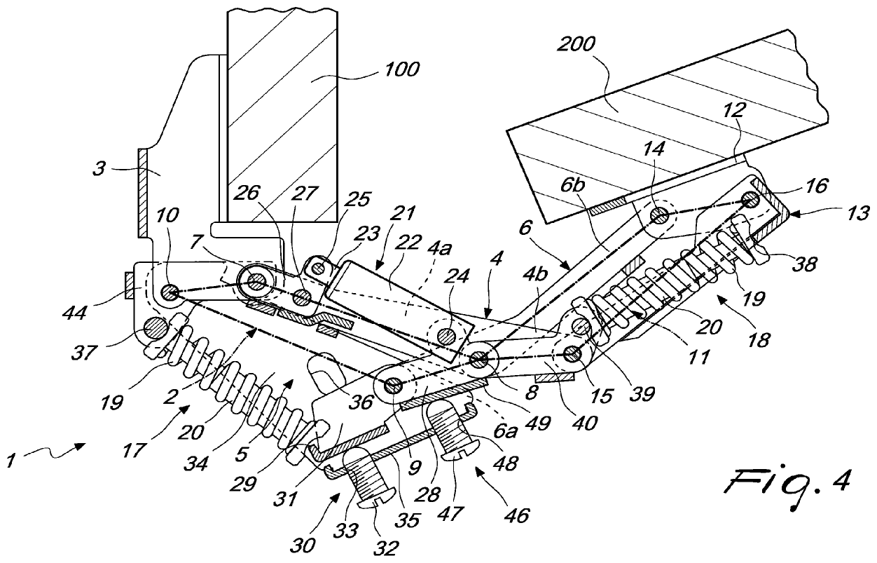

FIGS. 3 and 4 are cross-sectional views taken along a central plane of a variation of the first embodiment of the hinge according to the invention, respectively in the closed configuration and in the open configuration;

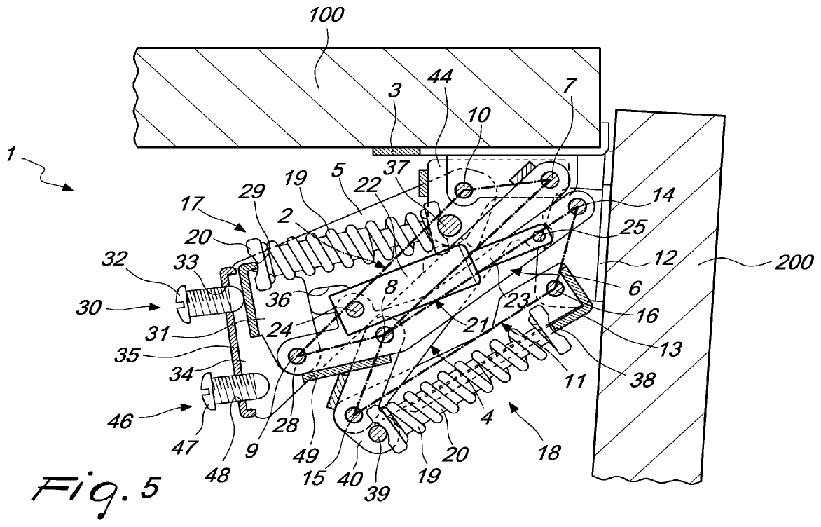

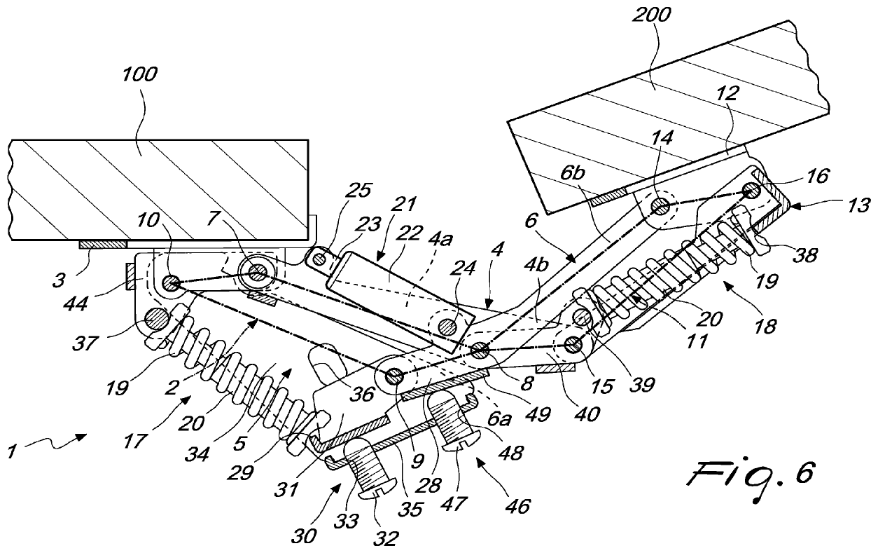

FIGS. 5 and 6 are cross-sectional views taken along a central plane of a second embodiment of the hinge according to the invention, respectively in the closed configuration and in the open configuration;

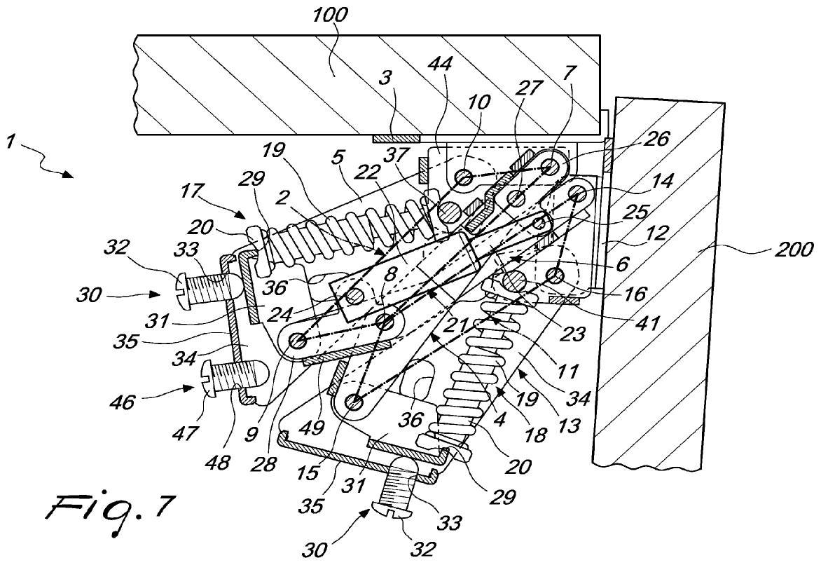

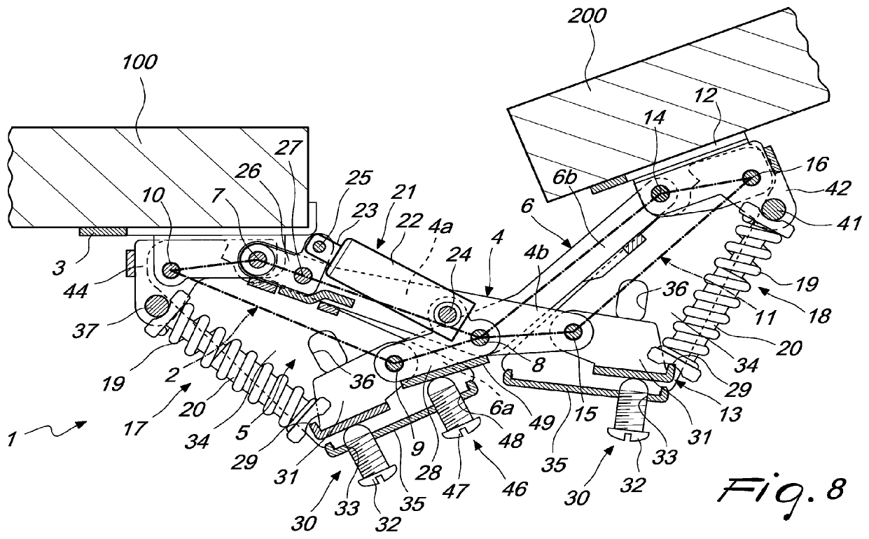

FIGS. 7 and 8 are cross-sectional views taken along a central plane of a third embodiment of the hinge according to the invention, respectively in the closed configuration and in the open configuration;

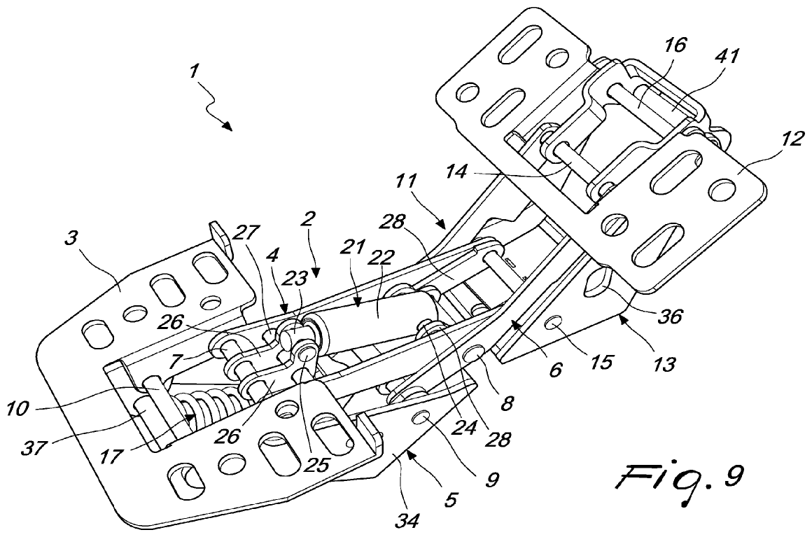

FIG. 9 is a perspective view of the third embodiment of the hinge according to the invention;

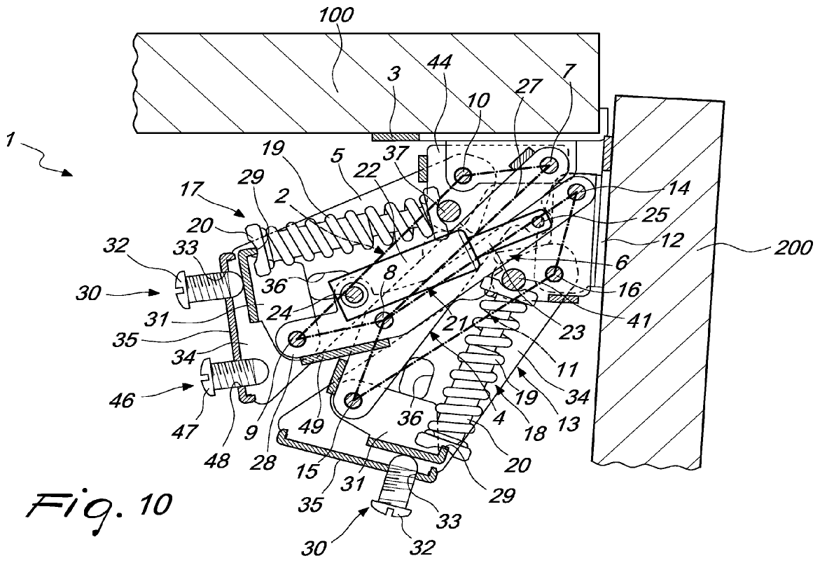

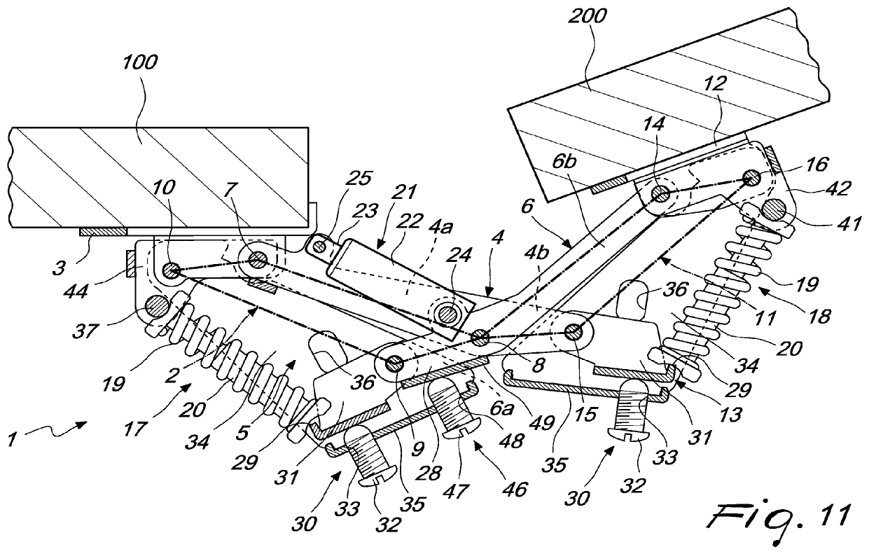

FIGS. 10 and 11 are cross-sectional views taken along a central plane of a fourth embodiment of the hinge according to the invention, respectively in the closed configuration and in the open configuration;

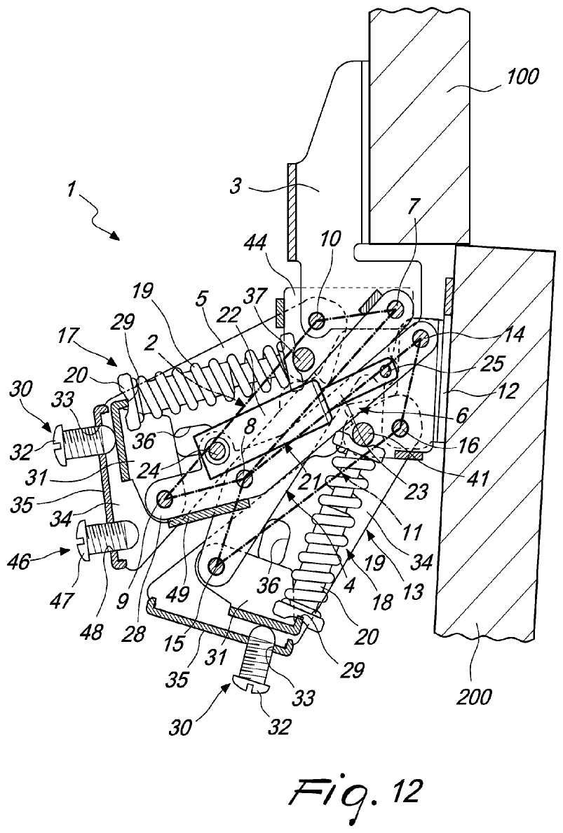

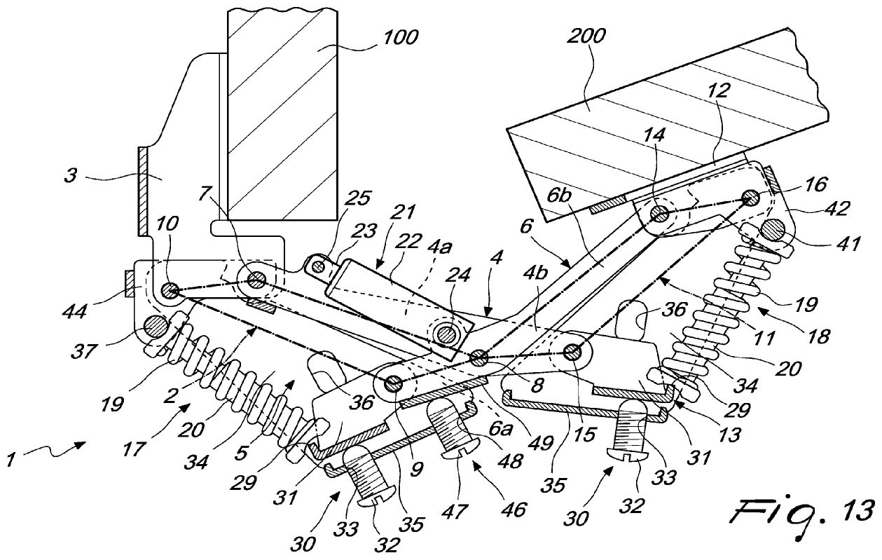

FIGS. 12 and 13 are cross-sectional views taken along a central plane of a variation of the fourth embodiment of the hinge according to the invention, respectively in the closed configuration and in the open configuration;

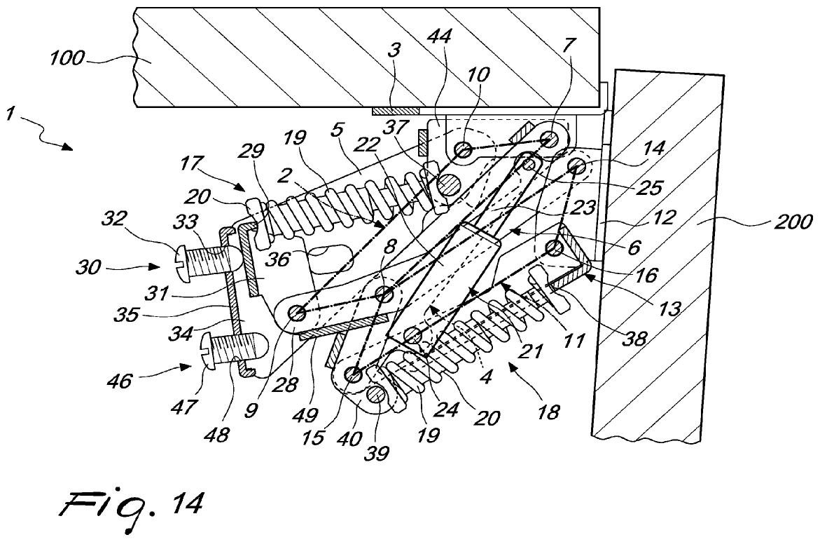

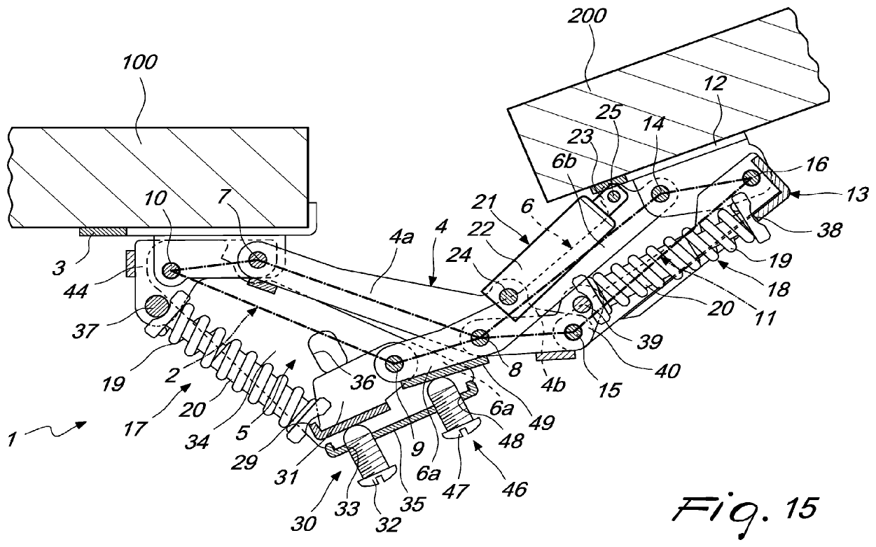

FIGS. 14 and 15 are cross-sectional views taken along a central plane of a fifth embodiment of the hinge according to the invention, respectively in the closed configuration and in the open configuration;

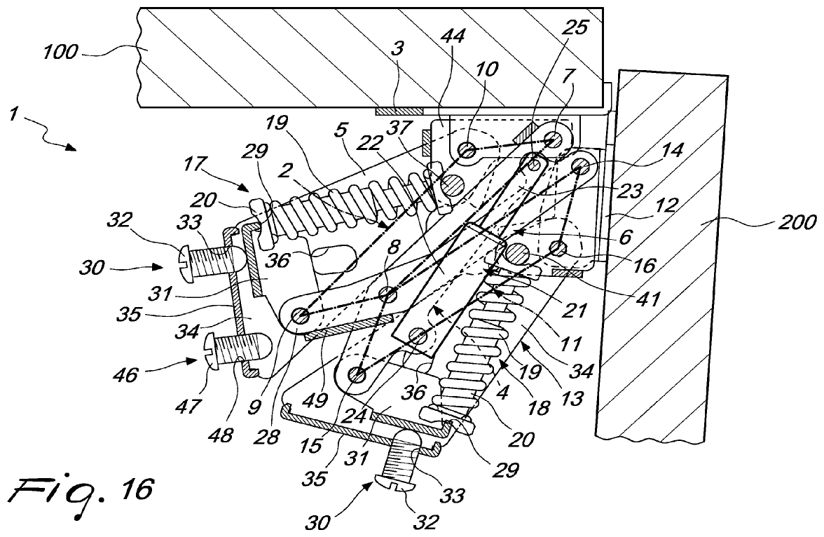

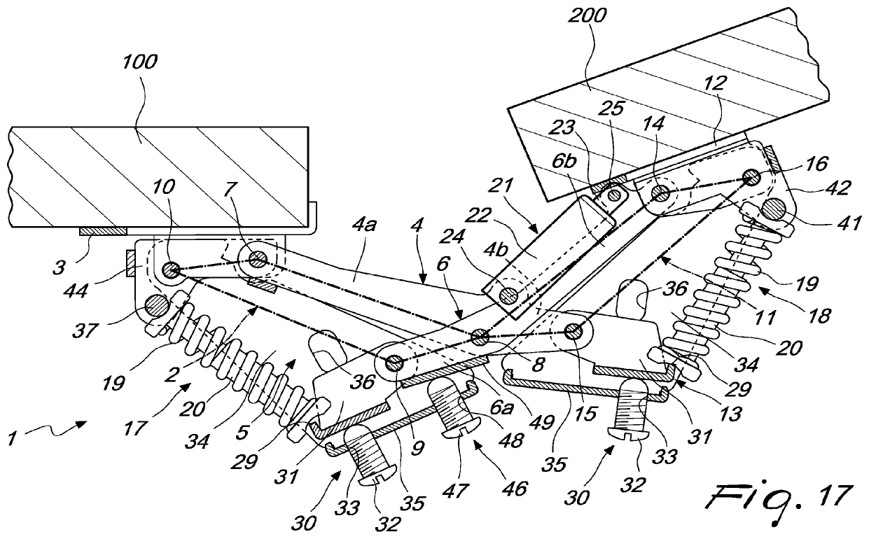

FIGS. 16 and 17 are cross-sectional views taken along a central plane of a sixth embodiment of the hinge according to the invention, respectively in the closed configuration and in the open configuration;

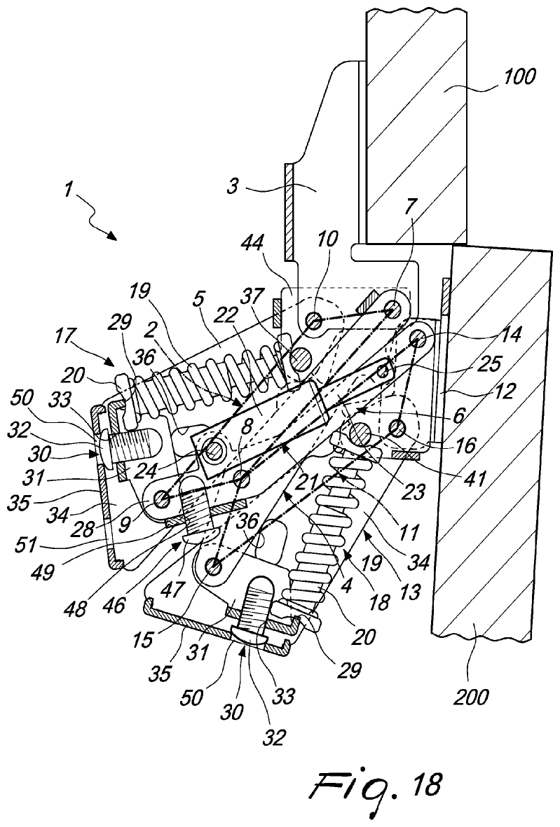

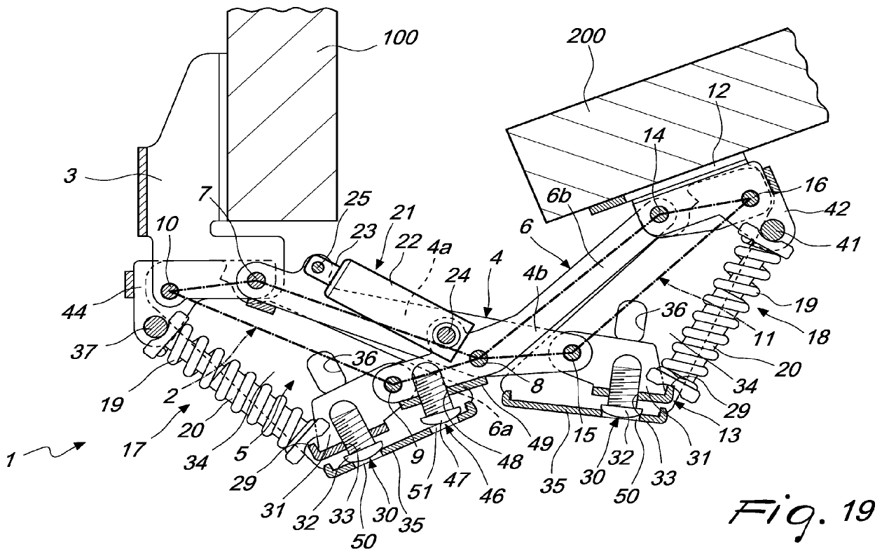

FIGS. 18 and 19 are cross-sectional views taken along a central plane of a seventh embodiment of the hinge according to the invention, respectively in the closed configuration and in the open configuration.

With reference to the figures, the reference numeral 1 generally designates an adjustable damped snap-acting hinge.

The hinge 1 comprises a first articulated quadrilateral 2 which comprises a coupling element 3 which can be associated with a fixed element 100, a first portion 4a of a first lever 4 and a third lever 5 which are associated in an articulated manner with the coupling element 3, and a first portion 6a of a second lever 6, which is interposed between the preceding levers and is articulated thereto.

The coupling element 3 can be variously shaped on the basis of the requirements of the specific application.

The fixed element 100 can be constituted, for example, by a wall of an item of furniture that defines a compartment.

Typically the fixed element 100 consists of a panel with a substantially horizontal or vertical arrangement. The shape of the coupling element 3 can vary as a function of the arrangement of the fixed element 100. For example FIGS. 3-4, 12-13, 18-19 illustrate a hinge 1 in which the coupling element 3 is adapted to be connected using screws (not shown) to a fixed element 100 with a vertical arrangement, at the inner face of the compartment of the item of furniture.

In the other figures, 1-2, 5-11, 14-17, the hinge 1 is provided with a coupling element 3 that is adapted to be connected using screws (not shown) to a fixed element 100 with a horizontal arrangement, at the inner face of the compartment of the item of furniture.

It should be noted that in the present description the term “substantially” means “except for the usual machining and assembly tolerances”.

In the figures, the articulation pivots interposed between the members of the first quadrilateral 2 are numbered as follows: 7 articulation pivot interposed between the coupling element 3 and the first portion 4a of the first lever 4; 8 articulation pivot interposed between the first lever 4 and the second lever 6; 9 articulation pivot interposed between the first portion 6a of the second lever 6 and the third lever 5; 10 articulation pivot interposed between the third lever 5 and the coupling element 3.

Such articulation pivots 7, 8, 9 and 10 are substantially mutually parallel.

Under normal conditions of use of the hinge 1, the rotation axes defined by the articulation pivots 7, 8, 9 and 10 have a substantially horizontal arrangement.

This hinge 1 further comprises a second articulated quadrilateral 11 which comprises a fixing element 12 which can be associated with an element 200 that can move with respect to the fixed element 100, a second portion 6b of the second lever 6 and a fourth lever 13 which are associated in an articulated manner with the fixing element 12, and a second portion 4b of the first lever 4 which is interposed between the preceding levers and is articulated thereto.

The fixing element 12 can be variously shaped on the basis of the requirements of the specific application.

The movable element 200 can be constituted for example by a door leaf or a door for closing the above mentioned compartment.

The movable element 200 is typically constituted by a flat or contoured panel.

In the figures, the articulation pivots of the members of the second quadrilateral 11 are numbered as follows: 14 articulation pivot interposed between the fixing element 12 and the second portion 6b of the second lever 6; 15 articulation pivot interposed between the second portion 4b of the first lever 4 and the fourth lever 13; 16 articulation pivot interposed between the fourth lever 13 and the fixing element 12.

The articulation pivots 14, 15 and 16 are substantially mutually parallel.

The articulation pivot 8 interposed between the first and the second lever 4 and 6 is common to the two articulated quadrilaterals 2 and 11. The articulation pivot 8 is substantially parallel to the articulation pivots 14, 15 and 16.

Under normal conditions of use of the hinge 1, the rotation axes defined by the articulation pivots 14, 15 and 16 also have a substantially horizontal arrangement.

The first and the second portion 4a and 4b of the first lever 4 constitute the extension of each other. The articulation pivots 7, 8 and 15 distributed along the first lever 4 are not mutually aligned, the first and the second portion 4a and 4b being inclined with respect to each other.

The first and the second portion 6a and 6b of the second lever 6 constitute the extension of each other. The articulation pivots 8, 9 and 14 distributed along the second lever 6 are not mutually aligned, the first and the second portion 6a and 6b being inclined with respect to each other.

The hinge 1 is adapted to alternately assume a closed configuration (FIGS. 1, 3, 5, 7, 10, 12, 14, 16, 18) and an open configuration (FIGS. 2, 4, 6, 8, 9, 11, 13, 15, 17, 19), passing through a plurality of intermediate configurations between the preceding ones, in which the fixing element 12 changes its arrangement with respect to the coupling element 3, which remains fixed in use.

The fixing element 12 varies its arrangement by an angle of aperture during the movement between the open and closed configurations.

The hinge 1 is further provided with first elastic compression means 17 associated with the first quadrilateral 2 and with second elastic compression means 18 associated with the second quadrilateral 11.

The first and the second elastic means 17 and 18 comprise, each, at least one helical compression spring 19, or other elastically deformable compression element.

Preferably each spring 19 is associated with a corresponding telescopic spring guide rod 20. Each spring guide rod 20 consists of a telescopic shaft accommodated inside the turns of the corresponding spring 19 and having at its mutually opposite ends respective locator caps coupled to the end turns of the spring itself. These locator caps are shaped in order to ensure that the springs 19 are held in position during the movement of the hinge 1.

Alternatively the spring guide rod could be constituted by a telescopic shell inside which the spring 19 or other elastic compression element is accommodated.

The first and/or the second elastic means 17 and/or 18 can have two or more springs 19 arranged between them in parallel.

In the embodiments shown, for example at least one of the first and second elastic means 17 and 18 has two springs 19 arranged in parallel on opposite sides of the midpoint plane, of which only one is visible in the figures.

Furthermore, the hinge 1 can have at least one damping element 21 associated with the first or with the second quadrilateral 2 or 11. The damping element 21 acts at least at the end part of the transition from the open configuration to the closed configuration.

Preferably such damping element 21 is interposed between the first and the second lever 4 and 6. In more detail, such damping element 21 can be associated with the first quadrilateral 2 and be interposed between the first portions 4a and 6a, respectively, of the first and of the second lever 4 and 6 (FIGS. 1-13, 18-19).

Alternatively the damping element 21 can be associated with the second quadrilateral 11 and be interposed between the second portions 4b and 6b, respectively, of the first and of the second lever 4 and 6 (FIGS. 14-17).

The damping element 21 is provided with a first end and with a second end, mutually opposite, which can move alternately toward and away from each other between an extended configuration, in which they are located at a maximum distance, and a retracted configuration, in which they are located at a minimum distance. These maximum and minimum distances can vary based on the dimensioning of the hinge 1 and of the corresponding damping element 21.

The damping element 21 is in the extended configuration when the hinge 1 is in the closed configuration. The damping element 21 is in the retracted configuration when the hinge 1 is in the open configuration.

Such damping element 21 is substantially constituted by a fluid-operated cylinder, comprising a jacket 22 inside which a piston, not visible in the figures, can move, integral with a protruding shaft 23. The operating chambers defined inside the jacket 22 on opposite sides of the piston are interconnected so as to allow the recirculation of the process fluid with which the jacket is filled.

The jacket 22 and the shaft 23 define the mutually opposite ends of the damping element 21.

The damping element 21 has the associated jacket 22 and shaft 23 articulated to the first or to the second quadrilateral 2 or 11 at respective articulation pivots 24 and 25.

Preferably such articulation pivots 24 and 25 are arranged outside the articulation pivots 7, 8, 9 and 10 or 14, 8, 15 and 16, and define the first or the second quadrilateral 2 or 11 when the hinge is in the open configuration.

Preferably the hinge 1 is provided with a damping element 21 that lies at a midpoint plane that is substantially perpendicular to the articulation pivots 7-10, 14-16. Such midpoint plane is substantially vertical under conditions of use of the hinge 1.

It should be noted that in the embodiments shown, each lever of the hinge 1 is constituted by two plate-like elements arranged on mutually opposite sides of the above mentioned midpoint plane and parallel thereto, and mutually connected by cross-members. The articulation pivots extend passing through the plate-like elements of the corresponding levers.

Advantageously the third or fourth lever 5 or 13 is constituted by a pair of side walls 34, parallel to the midpoint plane of the hinge 1, which are blended by a transverse spine 35.

If the damping element 21 is associated with the first quadrilateral 2 and is interposed between the first portions 4a and 6a, the articulation pivot 25 of the shaft 23 is supported by the first portion 4a and the articulation pivot 24 of the jacket 22 is supported by the first portion 6a.

The first lever 4 can be shaped to define an appendage for supporting the articulation pivot 25 (FIGS. 5-6, 10-13, 18-19) or there can be two supporting brackets 26 (FIGS. 1-4, 7-9) for supporting the articulation pivot 25 which are associated integrally with the first portion 4a of the first lever 4, being connected to it at the articulation pivot 7 and at an additional anchoring pin 27 which passes through the first lever 4 and the brackets themselves.

Similarly, the second lever 6 can be shaped to define an appendage for supporting the articulation pivot 24 (FIGS. 5-6, 10-13, 18-19) or there can be two supporting platelets 28 (FIGS. 1-4, 7-9) for supporting the articulation pivot 24 which are associated integrally with the first portion 6a of the second lever 6, being connected to it at the articulation pivots 8 and 9, which are inserted passing through the second lever 6 and the platelets themselves.

The possibility is not ruled out for the damping element 21 to be arranged with the jacket 22 associated in an articulated manner with the first portion 4a of the first lever 4 about the articulation pivot 24, and with the shaft 23 associated in an articulated manner with the first portion 6a of the second lever 6 about the articulation pivot 25.

If instead the damping element 21 is associated with the second quadrilateral 11 and is interposed between the second portions 4b and 6b, the articulation pivot 25 of the shaft 23 is supported by the second portion 6b and the articulation pivot 24 of the jacket 22 is supported by the second portion 4b.

The first lever 4 can be shaped to define an appendage for supporting the articulation pivot 24 (FIGS. 14-17) or there can be supporting elements for supporting this pivot which are associated integrally with the first lever 4, not shown.

Similarly, the second lever 6 can be shaped to define an appendage for supporting the articulation pivot 25 (FIGS. 14-17) or there can be supporting elements for supporting this pivot which are associated integrally with the second lever 6, not shown.

The possibility is not ruled out for the damping element 21 to be arranged with the jacket 22 associated in an articulated manner with the second portion 6b of the second lever 6 about the articulation pivot 24, and with the shaft 23 associated in an articulated manner with the second portion 4b of the first lever 4 about the articulation pivot 25.

In an alternative embodiment, not shown, the hinge 1 can lack the damping element 21.

According to the invention, either or both of the first or the second elastic means 17 or 18 is interposed between the coupling element 3 or the fixing element 12 and an abutment element 29 associated with at least one of the levers of the first or of the second quadrilateral 2 or 11, and there is at least one assembly 30 for adjusting the preloading of the first or of the second elastic means 17 or 18, which comprises a movable element 31 supporting the abutment element 29, which is associated with at least one of the levers of the first or of the second quadrilateral 2 or 11, and at least one pusher element 32 interposed between the third or fourth lever 5 or 13 and the movable element 31.

The variation of the position of the movable element 31 that is actuated via the pusher element 32 makes it possible to modify the preloading of the first or second elastic means 17 or 18.

Preferably the movable element 31 is associated in an articulated manner with at least one of the levers of the first or second quadrilateral 2 or 11.

Such abutment element 29 consists of a tooth adapted to engage in the notch defined in the corresponding abutment plate of the spring guide rod 20 of the corresponding spring 19.

If the adjustment assembly 30 is functionally associated with the first elastic means 17, then preferably, the movable element 31 can be associated in an articulated manner about the articulation pivot 9 of the first portion 6a of the second lever 6 and of the third lever 5.

If the adjustment assembly 30 is functionally associated with the second elastic means 18, then preferably, the movable element 31 can be associated in an articulated manner about the articulation pivot 15 of the second portion 4b of the first lever 4 and of the fourth lever 13.

The pusher element 32 consists of a first threaded element, of the type of a conventional screw, which is engaged in a corresponding internally threaded first hole 33 which is associated with one of either the third or the fourth lever 5 or 13 and the movable element 31, and is adapted to abut against the other one of those elements.

In more detail, in a possible embodiment (FIGS. 1-17), the first hole 33 is associated with the third or fourth lever 5 or 13 and the pusher element 32 is adapted to abut with its stem against the movable element.

Screwing the first threaded element 32 in the corresponding first hole 33 actuates the rotation of the movable element 29 in a first direction so as to compress the first or second elastic means 17 or 18, so increasing the preloading.

Unscrewing the first threaded element 32 from the corresponding first hole 33, by virtue of the reaction of the first or second elastic means 17 or 18, actuates the rotation of the movable element 29 in a second direction, opposite to the first, such as to reduce the preloading of the same elastic means.

Usefully the first hole 33 is directly provided in the third or fourth lever 5 or 13.

The first hole 33 can be made on the spine 35, preferably at the midpoint plane.

In an alternative embodiment (FIGS. 18-19), the first hole 33 is associated with the movable element 31 and the pusher element 32 is adapted to abut with its head against the third or fourth lever 5 or 13.

In this case the third or fourth lever 5 or 13 is provided with a first slot 50 at the head of the pusher element 32 for inserting a tool for screwing/unscrewing the element into/out of the corresponding first hole 33, of the type of a screwdriver or an Allen key.

The head of the pusher element 32 abuts against the third or fourth lever 5 or 13 at the peripheral region of the first slot 50.

The first slot 50 can be defined at the spine 35 of the third or fourth lever 5 or 13, the head of the pusher element 32 abutting inside the lever itself.

Screwing or unscrewing the pusher element 32 into or out of the second hole 48 modifies the angular position of the movable element 31 and, as a consequence, the preloading of the first or second elastic means 17 or 18.

Furthermore the adjustment assembly 30 can be provided with means 36 for visualizing the preloading imparted to the first or second elastic means 17 or 18 as a function of the position assumed by the first threaded element 32.

Such means 36 for visualizing comprise a pair of slots defined on the walls 34 through which a graduated scale on the movable element 31, not shown in the figures, can be seen.

The hinge 1 can have a single adjustment assembly 30 associated with the first elastic means 17 (FIGS. 1-6, 14-15), or a single adjustment assembly 30 associated with the second elastic means (not shown), or two adjustment assemblies 30 one of which is associated with the first elastic means 17 and the other is associated with the second elastic means 18 (FIGS. 7-13, 16-19).

Evidently the presence of one or two adjustment assemblies 30 associated with the first and/or with the second elastic means 17 and/or 18 makes it possible to extend the flexibility of use of the hinge 1 without substituting the springs 19.

If the hinge 1 is provided with two adjustment assemblies 30 then it obviously has the maximum flexibility of use for the same springs 19 used.

If the hinge 1 has an adjustment assembly 30 associated with the first elastic means 17, then at the coupling element 3 there is a first supporting pin 37 which is integral therewith, against which the first elastic means 17 abut. In more detail, the abutment plate of the spring guide rod 20 of the first elastic means 17 is provided with a notch for abutting rotatably against the first supporting pin 37, so that the spring 19 can change its arrangement during the movement of the hinge 1.

The coupling element 3 can be shaped to define an appendage for connection to the first supporting pin 37 or, as shown in the figures, there can be a pair of first platelets 44 which are shaped and associated integrally with the coupling element 3 at the articulation pivots 7 and 10, between which the first supporting pin 37 is interposed.

If the hinge 1 has a single adjustment assembly 30 associated with the first elastic means 17, then the second elastic means 18 are preferably interposed between the fourth lever 13 and the second portion 4b of the first lever 4. In this case the fourth lever 13 has an abutment profile 38 of the corresponding end cap of the spring guide rod 20 of the corresponding spring 19 and the second portion 4b of the first lever 4 carries a supporting pin 39 against which the other end cap of the spring guide rod 20 rotatably abuts.

The second portion 4b of the first lever can be shaped to define an appendage at which the supporting pin 39 is connected.

Alternatively, there can be a pair of wings 40 which are shaped and associated integrally with the second portion 4b of the first lever 4 at the articulation pivots 8 and 15, between which the supporting pin 39 is interposed.

If the hinge 1 has an adjustment assembly 30 associated with the second elastic means 18, then at the fixing element 12 there is a second supporting pin 41 which is integral therewith, against which the second elastic means 18 abut. In more detail, the end cap of the spring guide rod 20 of the second elastic means 17 is provided with a notch for abutting rotatably against the second supporting pin 41, so that the spring 19 can change its arrangement during the movement of the hinge 1.

The fixing element 12 can be shaped to define an appendage for connection to the second supporting pin 41 or, as shown in the figures, there can be a pair of second platelets 42 which are shaped and associated integrally with the fixing element 12 at the articulation pivots 14 and 16, between which the second supporting pin 41 is interposed.

The hinge 1 can comprise, lastly, means 46 for setting the breadth of the corresponding angle of aperture.

These setting means 46 comprise at least one settable stroke limiting element 47 which can be interposed between the first portion 6a of the second lever 6 and the third lever 5 or between the second portion 4b of the first lever 4 and the fourth lever 13.

Such stroke limiting element 47 comprises a second threaded element, of the type of a screw, which is engaged in a corresponding internally threaded second hole 48.

In a possible embodiment (FIGS. 1-17), the second hole 48 is associated with either the third 5 or fourth lever 13, and the stroke limiting element 47 is adapted to abut with its stem against the first portion 6a of the second lever 6 or against the second portion 4b of the first lever 4.

Preferably there is an abutment element 49 against the stem of the second threaded element associated with the first portion 6a of the second lever 6 or with the second portion 4b of the first lever 4.

The threaded second hole 48 can be defined on the spine 35 of the third or fourth lever 5 or 13.

Such setting means 46 are connected to the adjustment assembly 30 associated with the first and/or second elastic means 17 and/or 18.

Therefore if the hinge 1 has a single adjustment assembly 30 associated with the first elastic means 17 (FIGS. 1-6, 14-15), then the threaded second hole 48 is defined on the spine 35 of the third lever 5 and the second threaded element 47 is adapted to abut against the first portion 6a of the second lever 6.

The abutment plate 49 of the second threaded element 49 can be defined integrally with the second lever 6 or it can be radiused to the supporting platelets 28 which are integral with that second lever.

Alternatively, if the hinge 1 has a single adjustment assembly 30 associated with the second elastic means 18 (variation not shown), then the threaded second hole 48 is defined on the spine 35 of the fourth lever 13 and the second threaded element 47 is adapted to abut against the second portion 4b of the first lever 4.

If the hinge 1 has two adjustment assemblies 30 associated with the first and with the second elastic means 17 and 18 (FIGS. 7-13, 16-17), then there can be setting means 46 at each one of them or at both.

By way of example in the figures, the setting means 46 are arranged at the adjustment assembly 30 of the first elastic means 17, but they could be positioned at the adjustment assembly 30 of the second elastic means 17, by having a threaded second hole 48 on the spine 35 of the fourth lever 13 and an abutment plate 49 against the stem of the second threaded element 47 which is integral with the second portion 4b of the first lever 4.

In an alternative (FIGS. 18-19), the second hole 48 is associated with either the first portion 6a of the second lever 6 or the second portion 4b of the first lever 4 and the stroke limiting element 47 is adapted to abut with its head against either the third or fourth lever 5 or 13.

In this case the third or fourth lever 5 or 13 is provided with a second slot 51 at the head of the stroke limiting element 47 for inserting a tool for screwing/unscrewing the element into/out of the corresponding second hole 48, of the type of a screwdriver or an Allen key.

The head of the stroke limiting element 47 abuts against the third or fourth lever 5 or 13 at the peripheral region of the second slot 51.

The second slot 51 can be defined at the spine 35 of the third or fourth lever 5 or 13, the head of the stroke limiting element 47 abutting inside the lever itself.

In a variation of the hinge 1, not shown, the setting means 46 may be not provided.

FIGS. 1 and 2 show a first embodiment of the hinge 1 in which there is an adjustment assembly 30 of the first elastic means 17 and setting means 46 at the first quadrilateral 2.

The hinge 1 is provided with a damping element 21 interposed between the first portion 4a of the first lever 4 and the first portion 6a of the second lever 6.

The first portion 4a of the first lever 4 is associated integrally with supporting brackets 26 for supporting the articulation pivot 25 of the shaft 23 of the damping element 21. The first portion 6a of the second lever 6 is associated integrally with supporting platelets 28 for supporting the articulation pivot 24 of the jacket 22 of the damping element 21.

Furthermore, an abutment plate 49 of the second threaded element 47 is interposed between the supporting platelets 28.

The coupling element 3 is designed to be connected to a fixed element 100 with a horizontal arrangement.

FIGS. 3 and 4 show a variation of the first embodiment of the hinge 1 in which the coupling element 3 is designed to be connected to a fixed element 100 with a vertical arrangement.

FIGS. 5 and 6 show a second embodiment of the hinge 1 which differs from the first embodiment in that the first portion 4a of the first lever 4 and the first portion 6a of the second lever 6 have contoured tabs for supporting the articulation pivots 24 and 25 of the damping element 21. In this case the second threaded element 48 rests against an abutment plate 49 which is directly associated with the first portion 6a of the second lever 6.

FIGS. 7-9 show a third embodiment of the hinge 1 in which there are two adjustment assemblies 30, one cooperating with the first elastic means 17 and the other cooperating with the second elastic means 18 and setting means 46 at the first quadrilateral 2.

The hinge 1 is provided with a damping element 21 interposed between the first portion 4a of the first lever 4 and the first portion 6a of the second lever 6.

The first portion 4a of the first lever 4 is associated integrally with supporting brackets 26 for supporting the articulation pivot 25 of the shaft 23 of the damping element 21. The first portion 6a of the second lever 6 is associated integrally with supporting platelets 28 for supporting the articulation pivot 24 of the jacket 22 of the damping element 21.

Furthermore, an abutment plate 49 of the second threaded element 47 is interposed between the supporting platelets 28.

The coupling element 3 is designed to be connected to a fixed element 100 with a horizontal arrangement.

FIGS. 10 and 11 show a fourth embodiment of the hinge 1 which differs from the third embodiment in that the first portion 4a of the first lever 4 and the first portion 6a of the second lever 6 have contoured tabs for supporting the articulation pivots 24 and 25 of the damping element 21. In this case the second threaded element 48 rests against an abutment plate 49 which is associated directly with the first portion 6a of the second lever 6.

FIGS. 12 and 13 show a variation of the fourth embodiment of the hinge 1 in which the coupling element 3 is designed to be connected to a fixed element 100 with a vertical arrangement.

FIGS. 14 and 15 show a fifth embodiment of the hinge 1 in which there is an adjustment assembly 30 of the first elastic means 17 and setting means 46 at the first quadrilateral 2. The second threaded element 47 abuts directly against the first portion 6a of the second lever 6.

The hinge 1 is provided with a damping element 21 interposed between the second portion 4b of the first lever 4 and the second portion 6b of the second lever 6.

The second portion 4b of the first lever 4 and the second portion 6b of the second lever 6 have contoured tabs for supporting the articulation pivots 24 and 25 of the damping element 21.

The coupling element 3 is designed to be connected to a fixed element 100 with a horizontal arrangement.

FIGS. 16 and 17 show a sixth embodiment of the hinge 1 in which, differently from the fifth embodiment, there is an adjustment assembly 30 for the second elastic means 18 as well.

FIGS. 18 and 19 show a seventh embodiment of the hinge 1 which differs from the embodiment in FIGS. 12 and 13 in the positioning of the pusher elements 32 of the adjustment assemblies 30 and of the stroke limiting element 47 of the setting means 46.

It should be noted that in this embodiment the heads of the threaded elements 32 and 47 are arranged inside the third and fourth lever 5 and 14, so as to be protected from dust and residues and making the external appearance of the hinge 1 even more compact and pleasing.

In practice it has been found that the invention as described achieves the intended aim and objects and, in particular, attention is drawn to the fact that the hinge according to the invention offers maximum versatility of use and reliability of use, although it has reduced encumbrances and compact design.

The invention, thus conceived, is susceptible of numerous modifications and variations, all of which are within the scope of the appended claims.

Moreover, all the details may be substituted by other, technically equivalent elements.

In practice the materials employed, as well as the contingent dimensions and shapes, may be any according to requirements without for this reason departing from the scope of protection claimed herein.

The disclosures in Italian Patent Application No. 102021000012311 from which this application claims priority are incorporated herein by reference.

1.-15. (canceled)

16. An adjustable damped snap-acting hinge, comprising:
a first articulated quadrilateral which comprises a coupling element which is configured to be associated with a fixed element, a first portion of a first lever and a third lever which are associated in an articulated manner with said coupling element, and a first portion of a second lever, which is interposed between the first and third levers and is articulated thereto,
a second articulated quadrilateral which comprises a fixing element which is configured to be associated with an element that can move with respect to said fixed element, a second portion of said second lever and a fourth lever which are associated in an articulated manner with said fixing element, and a second portion of said first lever which is interposed between the preceding levers and is articulated thereto,
the hinge being adapted to assume alternately an open configuration and a closed configuration, said first, second, third and fourth levers rotating about respective articulation pivots which are substantially mutually parallel, and said fixing element varying arrangement thereof by an angle of aperture during a movement between the open and closed configurations,
the hinge being further provided with first elastic compression means associated with the first quadrilateral and with second elastic compression means associated with the second quadrilateral,
wherein either or both of said first and second elastic means is interposed between said coupling element or said fixing element and an abutment element associated with at least one of the levers of said first or second quadrilateral, and further comprising at least one adjustment assembly for adjusting a preloading of said first or second elastic means, which comprises a movable element supporting said abutment element and associated with at least one of the levers of said first or second quadrilateral, and at least one pusher element interposed between said third or fourth lever and said movable element, a variation of the position of the movable element that is actuated via the pusher element being adapted to modify the preloading of the first or second elastic means.

17. The hinge according to claim 16, wherein said movable element is associated in an articulated manner about the articulation pivot of the first portion of said second lever and of said third lever or about the articulation pivot of the second portion of said first lever and of said fourth lever.

18. The hinge according to claim 16, wherein said pusher element comprises a first threaded element which is engaged in a corresponding internally threaded first hole which is associated with one of either said third or fourth lever and said movable element, and is adapted to abut against the other one of said movable element and either said third or fourth lever.

19. The hinge according to claim 18, wherein said first hole is associated with said third or fourth lever and said pusher element is adapted to abut with its stem against said movable element.

20. The hinge according to claim 18, wherein said first hole is associated with said movable element and in that said pusher element is adapted to abut with its head against said third or fourth lever.

21. The hinge according to claim 16, wherein one or both of said third and said fourth lever comprises a pair of side walls which are blended by a spine.

22. The hinge according to claim 16, wherein said at least one adjustment assembly comprises means for visualizing the preloading imparted to the first or second elastic means as a function of the position assumed by said at least one pusher element.

23. The hinge according to claim 16, further comprising two of said adjustment assemblies which are functionally associated with said first and second elastic means.

24. The hinge according to claim 16, further comprising means for setting a breadth of said angle of aperture.

25. The hinge according to claim 24, wherein said setting means comprise at least one settable stroke limiting element which is interposed between the first portion of said second lever and said third lever or between the second portion of said first lever and said fourth lever.

26. The hinge according to claim 25, wherein said at least one stroke limiting element comprises a second threaded element which is engaged in a corresponding internally threaded second hole.

27. The hinge according to claim 26, wherein said second hole is associated with either said third or fourth lever, and said stroke limiting element is adapted to abut with its stem against the first portion of said second lever or against the second portion of said first lever.

28. The hinge according to claim 25, wherein said second hole is associated with either the first portion of said second lever or the second portion of said first lever, and said stroke limiting element is adapted to abut with its head against either said third or fourth lever.

29. The hinge according to claim 16, further comprising damping means associated with said first or with said second quadrilateral.

30. The hinge according to claim 29, wherein said damping means are interposed between the first portion of said first lever and the first portion of said second lever or between the second portion of said first lever and the second portion of said second lever.
